(19) United States
(12) Patent Application Publication
(10) Pub. No.: US 2005/0164686 A1
(43) Pub. Date: Jul. 28, 2005

(54) Presence enabled call forwarding with mobile user blocking in a cellular communication network

(75) Inventors: William Jackson Bushnell, St. Charles, IL (US); Tushar Ramesh Shah, Lombard, IL (US)

Correspondence Address: PATTON BOGGS, 1660 LINCOLN ST, SUITE 2050, DENVER, CO, 80264, US

(73) Assignee: Lucent Technologies, Inc., Murray Hill, NJ (US)

(21) Appl. No.: 11/086,866

(22) Filed: Mar. 21, 2005

Related U.S. Application Data
(63) Continuation-in-part of application No. 10/720,923, filed on Nov. 24, 2003.

(51) Int. Cl. H04M 3/42

(52) U.S. Cl. 455/417; 455/445

(57) ABSTRACT

The present system for providing presence enabled call forwarding serves to pass presence and supervision information relating to a user's wireless station set between a cellular communication network and an enterprise communication network, which typically includes a Private Branch Exchange system. The user is provided with the ability to control the forwarding of calls from the enterprise communication network to their cell phone. The user receives a query from the presence system when they activate their cell phone to indicate the availability of call forwarding blocking. The user can update their presence information to indicate that their cell phone is available to receive incoming calls directed to the cell phone, but not available to receive incoming calls that are forwarded from the enterprise communication network.

### CROSS-REFERENCE TO RELATED APPLICATIONS

This application is a continuation-in-part of U.S. patent application Ser. No. 10/720,923 titled “System For Providing Interoperability Of A Proprietary Enterprise Communication Network With A Cellular Communication Network” filed on Nov. 24, 2003.

### FIELD OF THE INVENTION

This invention relates to a system for providing user enabled call forwarding management in cellular communication networks which operate in conjunction with associated enterprise communication systems and networks to provide the associated enterprise communication systems and networks with presence and supervision information relating to a user's wireless station set.

### PROBLEM

It is a problem in enterprise communication networks that these networks are disjunct from the existing cellular communication networks. Therefore, to obtain service in both networks, the users who are served by the enterprise communication network must be equipped with two station sets, each with their own unique telephone numbers, with each number defining the user's presence in the corresponding network.

Enterprise communication networks consist of proprietary voice and data networks used to serve a predetermined set of users who are typically employed by a single entity. A Private Branch Exchange is typically used to provide voice-based services to these users, and associated Wire-Line or Wireless Local Area Networks are used for data connectivity. In this environment, the user is equipped with a wireless station set (or handset) or a wire-line telephone that is assigned a unique telephone number, which is served by the Private Branch Exchange. Connections to the Public Switched Telephone-Network for voice calls are via the Private Branch Exchange, while data connectivity to an IP Network is accomplished via a gateway, equipped with a firewall.

The existing cellular communication network consists of a plurality of Mobile Switching Centers, each of which serves one or more base station subsystems that provide the radio frequency links to the plurality of wireless station sets that are operational in each call coverage area (termed “cell”) provided by the associated base station subsystem. One Mobile Switching Center is typically termed the user's home Mobile Switching Center and it maintains the user's identification, authentication, and call services definition data in an associated Home Location Register which works in coordination with the ANSI-41 or GSM MAP Network. Other Mobile Switching Centers maintain their own Home Location Registers and also include Visited Location Registers to store call authorization data for users who roam out of their home service area to the call coverage area of the Visited Mobile Switching Centers. In this environment, the user is equipped with a wireless station set that is assigned a unique telephone number, and calls are processed by the Mobile Switching Center which serves the present location of the user. Both voice and data connectivity in the existing cellular communication network is through the serving Mobile Switching Center to the Public Switched Telephone Network and to an IP Network, respectively.

Thus, the user is provided with two different telephone station sets, one for each network, and associated different telephone numbers. Since the two networks are not interoperated together, all incoming calls are routed solely on the dialed number, not the presence of the user in one of these networks. Furthermore, the services provided by each network are not extensible to the other network.

A further problem with this architecture is that, to ensure that a user can be reached regardless of their location, a variety of services are available to allow incoming calls, which are directed to the enterprise communication network, to be forwarded to the user's wireless telephone station set on the cellular communication network (termed “cell phone” herein). These services include: call forward all calls to the user's cell phone; call forward calls to the user's cell phone on Do Not Answer; and time of day forwarding of calls to the user's cell phone. A problem with these services is that incoming calls that are forwarded to the user's cell phone are redirected to the user's cellular communication network voice mailbox if the user's cell phone is busy or not active. In addition, the forwarding of a large number of calls to the user's cell phone can result in significant cellular communication network airtime charges for the user's cell phone.

U.S. patent application Ser. No. 10/720,923 titled “System For Providing Interoperability Of A Proprietary Enterprise Communication Network With A Cellular Communication Network” describes a system for providing interoperability of a proprietary enterprise communication network with a cellular communication network which serves to pass presence and supervision information relating to a user's wireless station set between a cellular communication network and an enterprise communication network, which typically includes a Private Branch Exchange system. The user is equipped with a wire-line station set which is served by the enterprise system and a wireless station set which is capable of communicating with the base station subsystems of the existing cellular communication network in a conventional manner when the user is present in the coverage area of the cells of the cellular communication network.

The interoperability system functions to extend incoming calls, which are directed to the user, from the enterprise communication network to the cellular communication network based on the presence and supervision data provided by the interoperability system. The provision of ubiquitous service to the user, regardless of their location, provides a significant advantage over existing Private Branch Exchange and cellular communication network services. However, when the user activates their cell phone, the interoperability system uses the presence information to redirect all calls to the cell phone. The system does not provide the user with the capability to controllably enable the presence and supervision feature. This is a problem when the user wishes to initiate an outgoing call or receive incoming calls directed to their cell phone, without also receiving all calls that are redirected from the wire-line phone in the enterprise communication network.

### SOLUTION

The above-described problems are solved and a technical advance achieved by the present system for providing presence enabled call forwarding with mobile user blocking in a cellular communication network (termed “system for providing presence enabled call forwarding” herein) which serves to pass presence and supervision information relating to a user's wireless station set between a cellular communication network and an enterprise communication network, which typically includes a Private Branch Exchange system or a Centrex system. The user is equipped with a wireless station set which is served via one or more cell sites of the existing cellular communication network in a conventional manner when the user is present in the coverage area of the cells of the cellular communication network. The user is also equipped with a wire-line station set which is served by the enterprise communication network, or optionally a dual mode phone that operates in both the cellular communication network and the enterprise communication network. The provision of ubiquitous service to the user, regardless of their location, provides a significant advantage over existing Private Branch Exchange and cellular communication network services.

Furthermore, the user is provided with the ability to control the forwarding of calls from the enterprise communication network to their cell phone to thereby forward calls only when the cell phone is both available and idle. If the cell phone is not both available and idle, the incoming call to the enterprise communication network is directed to a voice mail service associated with the enterprise communication network. This presence enabled call forwarding capability is further enhanced by the ability of the user to activate their cell phone so that they can originate calls and/or receive calls directed to their cell phone, but they can simultaneously block call forwarding to their cell phone. The user receives a query from the presence system when they activate their cell phone to indicate the availability of call forwarding blocking. The user can update their presence information to indicate that their cell phone is available to receive incoming calls directed to the cell phone, but not available to receive incoming calls that are forwarded from the enterprise communication network.

### BRIEF DESCRIPTION OF THE DRAWINGS

FIG. 1 illustrates, in block diagram form, the architecture of existing communication networks, including a proprietary enterprise communication network and a cellular communication network that are equipped with the present system for providing presence enabled call forwarding;

FIGS. 2A and 2B illustrate, in flow diagram form, the operation of the present system for providing presence enabled call forwarding in an existing communication network, including a proprietary enterprise communication network and a cellular communication network; and

FIG. 3 illustrates additional details of the network interoperability system.

### DETAILED DESCRIPTION

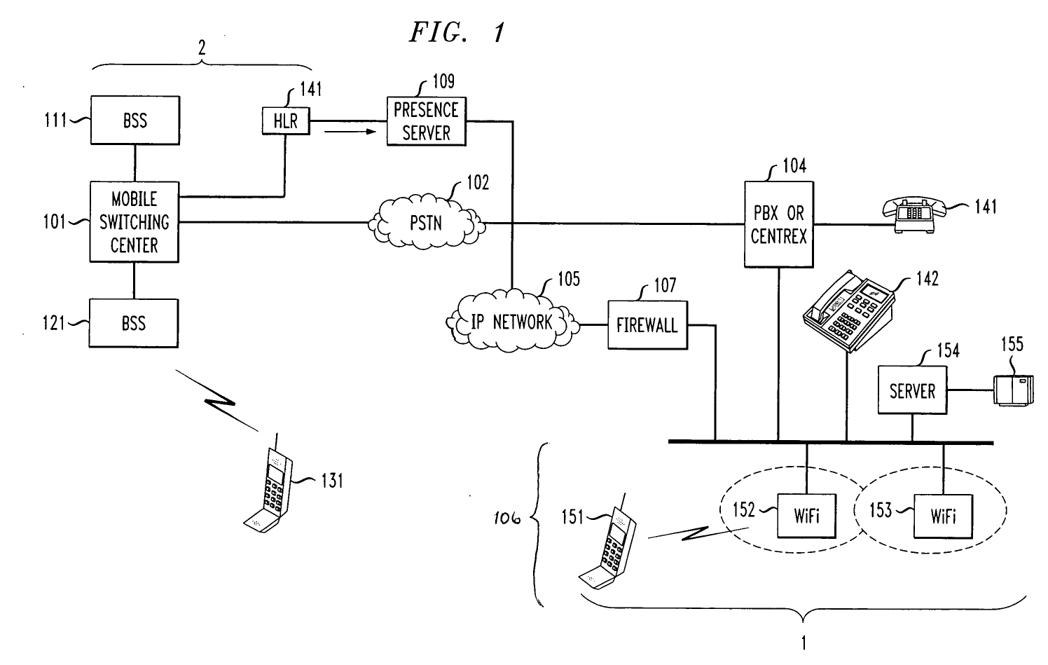

FIG. 1 illustrates in block diagram form the architecture of existing communication networks, including a proprietary enterprise communication network and a cellular communication network that are equipped with the present system for providing presence enabled call forwarding.

A cellular communication network 2 consists of a plurality of Mobile Switching Centers 101, each of which serves one or more base station subsystems (such as 111, 121) that provide the radio frequency links to the plurality of wireless station sets 131 that are operational in each call coverage area, termed “cell” (not shown), provided by the associated base station subsystem. One Mobile Switching Center 101 is typically termed the user's home Mobile Switching Center and it maintains the user's identification, authentication, and call services definition data in an associated Home Location Register 141. Other Mobile Switching Centers (not shown) maintain their own Home Location Registers and Visited Location Registers to store call authorization data for users who roam out of their home service area to the call coverage area of the Visited Mobile Switching Centers. The Mobile Switching Center 101 is connected to the Public Switched Telephone Network 102 for voice calls and to the Public IP Network 105 for data calls.

Enterprise communication networks 1 typically consist of proprietary voice and data networks used to serve a predetermined set of users who are typically employed by a single entity. A Private Branch Exchange 104 is typically used to provide voice-based services to the users via various communication devices, such as Plain Old Telephone Sets 141, IP Telephones 142, and the like. The associated Wire-line or Wireless Local Area Networks 106 (not shown) are used for data connectivity to serve wireless station sets, such as 151 via WiFi nodes 152, 153, as well as servers 154 that interconnect back-data storage and/or processing elements 155. Conventional data terminals can also be served by the associated Wire-line or Wireless Local Area Networks 106 either via a direct wired connection to the Wire-line network or via a radio frequency link to Wireless Local Area Networks 106. In this environment, the user is equipped with a wire-line station set 141 that is assigned a single unique telephone number, which is served by the Private Branch Exchange 104. Alternatively, the user can be equipped with a wireless station set 151 that is assigned a single unique telephone number, which is served by the Private Branch Exchange 104 via WiFi nodes 152, 153. Connections to the Public Switched Telephone Network 102 for voice calls are via the Private Branch Exchange 104, while data connectivity to an IP Network 105 is accomplished via a gateway 107, equipped with a firewall.

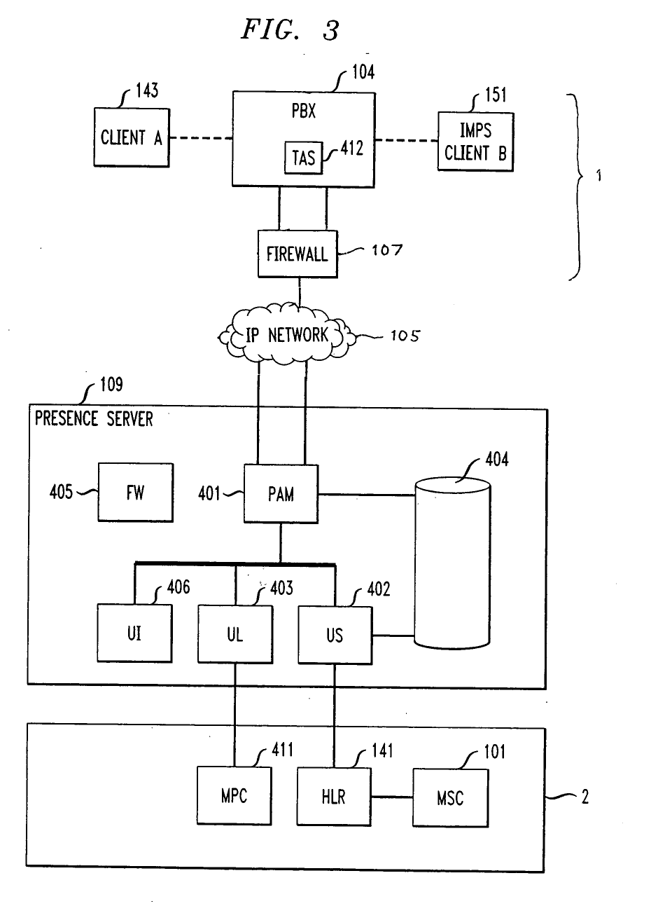

The Presence Server 109 which is connected to both the Home Location Register 141 of the cellular communication network 2 and an element, typically the Private Branch Exchange 104, of the enterprise communication network 1 and its associated interconnections illustrated in FIG. 3, which together comprise the present system for providing presence enabled call forwarding.

The cellular communication network 2 provides the presence and supervision management for the roaming user's wireless station set 131. Once the user's wireless station set 131 is activated, the user's wireless station set 131 registers with the serving Mobile Switching Center 101 and the user's Home Location Register 141 is updated with the mobile user presence data. The Home Location Register 141 passes the presence status data of the user's wireless station set 131 to the Presence Server 109, which communicates with the Private Branch Exchange 104. The interface between the Private Branch Exchange 104 and the Presence Server 109 is typically an open interface, since the Presence Server 109 typically serves multiple Private Branch Exchange 104 systems. The Private Branch Exchange 104 includes apparatus to interface with the Presence Server 109, such as inquiry software to enable the call controller functions to generate an inquiry for transmission to the Presence Server 109 to determine whether the user is presently being served by the cellular communication network 2. For example, the industry standard Parlay API can be used to allow the enterprise Private Branch Exchange 104 to query the Presence Server 109 in a mobile network. The status data maintained in the Presence Server 109 is updated on a periodic or demand basis. The Presence Server 109 is shown as a stand-alone element, but this functionality can alternatively be integrated, in whole or in part, into the cellular communication network 2 (such as the Home Location Register 141).

System For Providing Presence Enabled Call Forwarding

The concept of presence technology is to enable the network to know the status and availability of a user to thereby improve communication efficiency. The concept of presence was initially associated with Instant Messaging service, where a user was advised whether a colleague is available to receive messages. The present system for providing presence enabled call forwarding extends this concept to include monitoring the registration and status of any type of user device, including wireless telephones, VoIP Clients, traditional POTS telephones, Push to Talk Clients, multimedia clients, etc. Furthermore, the concept of presence has been extended to include Availability, where a user can explicitly share their availability for communicating with colleagues. Typical availability states include: out of the office, in a meeting with a client, in a conference call, on vacation, sick, etc. A user can provide this information, or it can be inferred from the user's on-line calendar.

By collecting and disseminating the suite of presence information (status of user device, and availability of the user), a call to an office wire-line phone can be forwarded to a wireless phone only if the wireless phone is available.

As shown in FIG. 3, the Presence Server 109 includes a plurality of elements, which include:
FM—Framework 405
PAM—Presence and Availability Management 401
US—User Status 402
UI—User Identification 406

These various elements perform the basic interoperability functions including:
Collection of network presence information
Storage of presence information both explicit and implicit
Handling implicit network terminal status updates
Maintenance of the user's presence policy
Authorization and authentication

The Presence Server 109 is connected via the US—User Status 402 to the Home Location Register 141 in the cellular communication network 2 to obtain the present status of the user's wireless station set 131 as determined by the Mobile Switching Center 101. In addition, the UI—User Identification 406 element functions to validate the identity of a user when an inquiry or status update is received. The Presence and Availability Management 401 element performs the information management, retrieval, and delivery functions by coordinating the operation of the above-noted components of the Presence Server 109 with components, such as the Telephone Access Server 412 resident in the Private Branch Exchange 104, to access status information from the Presence Server 109 for the user's wireless station set. The database of user information is maintained in memory 404 and Framework 405 represents the Presence Server administration component, responsible for the registration of the various PBXs and applications that interconnect with the Presence Server 109.

Operation of the System For Providing Presence Enabled Call Forwarding

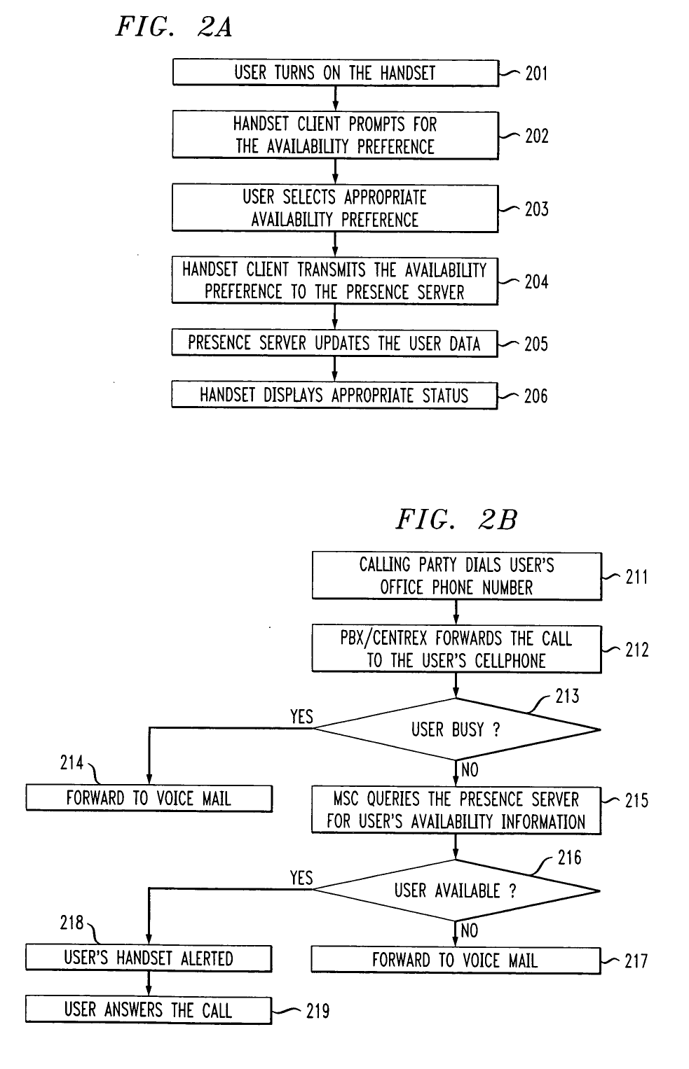

FIGS. 2A and 2B illustrate, in flow diagram form, the operation of the present system for providing presence enabled call forwarding in an existing communication network, including a proprietary enterprise communication network and a cellular communication network.

Selection of Availability Preference

The user is provided with the ability to control the forwarding of calls from the enterprise communication network to their cell phone to thereby forward calls only when the cell phone is both available and idle. If the user's cell phone is not both available and idle, the incoming call to the enterprise communication network can be automatically directed to a voice mail service associated with the enterprise communication network or some alternative call handling service. This presence enabled call forwarding capability is further enhanced by the ability of the user to activate their cell phone so that they can originate calls, but they can simultaneously block call forwarding to their cell phone.

The user at cell phone 131 activates their cell phone at step 201 and receives a query at step 202 from the handset client process that executes on the cell phone 131. This query provides a display on the cell phone 131 to prompt the user for the present availability preference. The user can update their presence information as stored in presence server 109 at step 203 to either temporarily block the call forwarding service at the enterprise communication network 1 by indicating that their cell phone 131 is available to receive incoming calls directed to the cell phone 131, but not available to receive incoming calls that are forwarded from the enterprise communication network 1, or to activate call forwarding by indicating that their cell phone is available to receive incoming calls directed to the cell phone. At step 204, the handset client process that executes on the cell phone 131 transmits the availability preference data to the presence server 109, where the user data is updated at step 205. The handset client process that executes on the cell phone 131 displays the appropriate availability preference status to the user at step 206.

Incoming Call Processing

As an example of the operation of the system for providing presence enabled call forwarding, the presence and supervision information is used to extend the services provided by the Private Branch Exchange 104 to the user while the user is roaming in the cellular-communication network 2. For example, at step 211, an incoming call from a calling party is directed to the user's wire-line station set 141 via the user's telephone number on Private Branch Exchange 104. This incoming call is routed through the Public Switched Telephone Network 102 to the Private Branch Exchange 104. If the user has activated call forwarding, the Telephone Access Server 412 of the Private Branch Exchange 104, in response to the receipt of the incoming call, queries the Presence Server 109 to see if the user's cell phone 131 is available to receive calls at step 212. The Presence Server 109 may indicate that the cell phone 131 is not available because the cell phone 131 is not active or because the user has manually set their presence status to not available. If the Presence Server 109 indicates that the cell phone 131 is not available at step 213, the Private Branch Exchange 104 forwards the call to an attendant (not shown) or to voice mail at step 214. If the Presence Server 109 indicates that the cell phone 131 is available at step 213, the Private Branch Exchange 104 forwards the incoming call at step 215 to the user's cell phone 131, at which time the Mobile Switching Center 101 at step 216 determines whether the user's cell phone 131 is busy. If the user's cell phone 131 is busy, the incoming call is rerouted at step 217 pursuant to the features activated by the user, to an alternative destination, such as to voice mail. If the Mobile Switching Center 101 determines at step 216 that the user's cell phone 131 is not busy, processing advances to step 218 where the user's cell phone 131 is alerted to the presence of the call forwarded incoming call. The user, in response to the alert at step 218, answers the incoming call at step 219.

Summary

The system for providing presence enabled call forwarding serves to pass presence and supervision information relating to a user's wireless station set between a cellular communication network and an enterprise communication network, which typically includes a Private Branch Exchange system, to provide consistency of the service provided to the user, regardless of location.

1. A system for providing presence enabled call forwarding in a cellular communication network for providing call forwarding communication services to users' cell phones which are located in the coverage area of a said cellular communication network, comprising:
presence server means for storing user data representative a service status of a user's cell phone, comprising:
call forwarding status means for identifying a call forwarding service state for said user's cell phone; and
query means for exchanging said user data with at least one of said enterprise communication network and said public communication network.

2. The system for providing presence enabled call forwarding in a cellular communication network of claim 1 wherein said query means comprises:
call forwarding query means, responsive to a query received from a one of said enterprise communication network and said public communication network, for providing said user with a display on said user cell phone indicative of call forwarding status options that can be selected by said user.

3. The system for providing presence enabled call forwarding in a cellular communication network of claim 2 wherein said call forwarding status means comprises:
call forwarding activation means, responsive to data received from said user cell phone, for providing said enterprise communication network with data indicative of activation and disabling of a call forwarding service on said enterprise communication network.

4. The system for providing presence enabled call forwarding in a cellular communication network of claim 3 wherein said query means further comprises:
call forwarding state change means, responsive to data received from said user cell phone indicative of one of activation and disabling of a call forwarding service on said enterprise communication network by said user, for forwarding said data to said enterprise communication network.

5. The system for providing presence enabled call forwarding in a cellular communication network of claim 2 wherein said call forwarding status means comprises:
call forwarding blocking means, responsive to data received from said user cell phone, for providing said enterprise communication network with data indicative of activation of blocking a presently activated call forwarding service on said enterprise communication network.

6. The system for providing presence enabled call forwarding in a cellular communication network of claim 5 wherein said query means further comprises:
call forwarding state change means, responsive to data received from said user cell phone indicative of blocking of a presently active call forwarding service on said enterprise communication network by said user, for forwarding said data to said enterprise communication network.

7. A method of providing presence enabled call forwarding in a cellular communication network for users' cell phones which are located in the coverage area of a said cellular communication network, comprising:
storing user data representative a service status of a user's cell phone, comprising:
identifying a call forwarding service state for said user's cell phone; and
exchanging said user data with at least one of said enterprise communication network and said public communication network.

8. The method of providing presence enabled call forwarding of claim 7 wherein said step of exchanging comprises:
providing, in response to a query received from a one of said enterprise communication network and said public communication network, said user with a display on said user cell phone indicative of call forwarding status options that can be selected by said user.

9. The method of providing presence enabled call forwarding of claim 8 wherein said step of identifying a call forwarding service state comprises:
providing, in response to data received from said user cell phone, said enterprise communication network with data indicative of one of activation and disabling of a call forwarding service on said enterprise communication network.

10. The method of providing presence enabled call forwarding of claim 9 wherein said step of exchanging further comprises:
forwarding, in response to data received from said user cell phone indicative of one of activation and disabling of a call forwarding service on said enterprise communication network by said user, said data to said enterprise communication network.

11. The method of providing presence enabled call forwarding of claim 8 wherein said step of identifying a call forwarding service state comprises:
providing, in response to data received from said user cell phone, said enterprise communication network with data indicative of activation of blocking a presently activated call forwarding service on said enterprise communication network.

12. The method of providing presence enabled call forwarding of claim 11 wherein said step of exchanging further comprises:
forwarding, in response to data received from said user cell phone indicative of blocking of a presently active call forwarding service on said enterprise communication network by said user, said data to said enterprise communication network.
